(19) United States
(12) Patent Application Publication
(10) Pub. No.: US 2023/0099521 A1
(43) Pub. Date: Mar. 30, 2023

(54) 3D MAP AND METHOD FOR GENERATING A 3D MAP VIA TEMPORAL AND UNIFIED PANOPTIC SEGMENTATION

(71) Applicants: Zhiliu Yang, Potsdam, NY (US); Chen Liu, Potsdam, NY (US)

(72) Inventors: Zhiliu Yang, Potsdam, NY (US); Chen Liu, Potsdam, NY (US)

(73) Assignee: CLARKSON UNIVERSITY, POTSDAM, NY (US)

(21) Appl. No.: 17/954,976

(22) Filed: Sep. 28, 2022

Related U.S. Application Data
(60) Provisional application No. 63/249,045, filed on Sep. 28, 2021.

(51) Int. Cl. G06T 7/194; G06T 7/215

(52) U.S. Cl. CPC G06T 7/194; G06T 7/215; G06T 2207/20084

(57) ABSTRACT

A system for generating a semantic 3D map, that includes at least one image capture device capable of capturing and transmitting digital frames of images; a temporal and unified panoptic segmentation module programmed, structed, and/or configured to receive the frames of images from the at least one image capture device and integrate a heuristic panoptic label fusion module with a loss function of a neural network to realize end-to-end panoptic segmentation; a geometric segmentation module programmed, structured and/or configured to receive the frames of images from the at least one image capture device and for discovering previously unseen scene elements, wherein at every frame, it generates a set of closed 2D regions and a set of corresponding 3D segments from a depth image; a segmentation refinement module programmed, structed, and/or configured to refine geometric labels using panoptic labels; and a 3D volumetric integration module programmed, structed, and/or configured to directly register each pixel of object segments into 3D space without checking the IoU ratio with historical information.

### CROSS-REFERENCE TO RELATED APPLICATION

This application claims priority to U.S. Provisional Patent Application Ser. No. 63/249,045, filed on Sep. 28, 2021, and entitled “3D Mapping via Temporal and Unified Panoptic Segmentation,” the entire disclosure of which is incorporated herein by reference.

### GOVERNMENT FUNDING

N/A

### FIELD OF THE INVENTION

The present disclosure is directed generally to 3-D semantic maps used with robots and autonomous vehicles.

### BACKGROUND

Semantic knowledge can help an autonomous robot or vehicle move/navigate as desired and without inadvertently running into undesired things. Thus, part of this knowledge has to be about objects, functionalities, events, or relations in the robot's/vehicle's environment. The data structure holding the space-related information about this environment is referred to as a map. Typical state-of-the-art robot maps represent the environment geometry; often in 2D, sometimes in 3D, sometimes topologically. Additional sensor-relevant information such as specific features or texture may also be within the knowledge scope. A “semantic map” augments that by information about entities, i.e., objects, functionalities, or events, that are located in space.

Based on the recent study on semantic object-level mapping, the core problem is how to discover unknown objects without pre-defining an object database, while at the same time provide the correct semantic information. Methods using pure geometry-based knowledge to detect object are good at discovering novel objects. One method is to build an object-oriented map first, but this method requires a pre-collected database for matching. Another method is able to recognize unseen objects while still relying on a 3D geometric database. Recent learning-based methods perform well in handling intra-class variability of trained objects, but they are not able to detect novel objects.

One method adopts Convolutional Neural Networks (“CNNs”) to realize dense scene understanding while not disambiguating individual instances. Other methods firstly designed Simultaneous Localization and Mapping (“SLAM”) system able to construct an instance-aware map, but these are not able to handle background area in the scene. One method adding another instance label layer on top of truncated signed distance function (“TSDF”) map integration, but it does not reach a holistic scene understanding, where background areas such as floor are treated as separate objects, rather than an entire object. One method introduced panoptic segmentation into semantic map building, while their separate two-branch panoptic networks is not able to take advantage of complementary feature of front objects and background objects. Even though it was stated that their method is not limited for indoor case, but no outdoor result was presented. Besides, all previous semantic mapping methods utilize a map reference-based data association method, which highly relies on empirical threshold.

One of the most recent semantic mapping works mainly focuses on the localization performance of the system, where their semantic reconstruction module is not the state-of-the-art. Meanwhile, the attempts to fuse geometry information and learning-based detection result is promising to improve the map quality. Pre-processing method such as geometry-based segmentation or post-processing method such as conditional random field (“CRF”)-based map regulation verified the practical role of geometry information in the real-world application.

In computer vision, there is a trend to extend the progress from image domain problem to video domain problem. Mask R-CNN was leveraged to detect object instances for most semantic mapping frameworks. After that, researchers defined the problem of panoptic segmentation and demonstrated a vanilla panoptic model. Later, unified models improved the performance of image-based panoptic segmentation via integrating two separate branches of semantic segmentation and instance segmentation into a single network. Following the method that video instance segmentation incorporates instance segmentation from image domain into the video domain, video panoptic segmentation was proposed to solve the holistic scene understanding in a continuous sequence of video frames. The traditional map reference-based data association approach counts on the label-wise intersection ratio between current frame pixels and historical voxels stored in the 3D map. There are similarities between video panoptic segmentation and data association in the semantic mapping, so we have the temporal relationship to fuse the semantic map, to move forward to the direction of end-to-end semantic mapping.

Accordingly, there is a need in the art for unifying previously separated semantic segmentation and instance segmentation into a single network for metric-panoptic mapping, leveraging deep neural network (“DNN”)-based data association for tracking object instances across different frames in metric-panoptic mapping, and developing volumetric map pruning based on panoptic label information.

### SUMMARY

The present disclosure is directed to a 3D map and method for generating a 3D map via temporal and unified panoptic segmentation.

According to an aspect is a system for generating a semantic 3D map, comprising at least one image capture device capable of capturing and transmitting frames of images; a temporal and unified panoptic segmentation module programmed, structed, and/or configured to receive the frames of images from the at least one image capture device and integrate a heuristic panoptic label fusion module with a loss function of a neural network to realize end-to-end panoptic segmentation; a geometric segmentation module programmed, structured and/or configured to receive the frames of images from the at least one image capture device and for discovering previously unseen scene elements, wherein at every frame, it generates a set of closed 2D regions and a set of corresponding 3D segments from a depth image; a segmentation refinement module programmed, structed, and/or configured to refine geometric labels using panoptic labels; and a 3D volumetric integration module programmed, structed, and/or configured to directly register each pixel of object segments into 3D space without checking the intersection over union (“IoU”) ratio with historical information.

According to an embodiment, the temporal and unified panoptic segmentation module includes a convolutional feature extraction backbone, which exploits residual neural network (“ResNet”) with a feature pyramid network (“FPN”).

According to an embodiment, the system further comprises a data association module comprising a fuse stage and a track stage.

According to an embodiment, the fuse stage is structured and/or configured to receive current frame and reference frame and feed them into a flow net module to estimate an initial optical flow.

According to an embodiment, the segmentation refinement module is further programmed, structed, and/or configured to calculate intersection over union (“IoU”) of thing objects and for stuff objects, wherein thing objects is data representative of foreground instances and stuff objects is data representative of background regions, all of which can be stored as voxels.

According to an embodiment, the system further comprises a pruning module programmed, structured, and/or configured to remove at least some of the stuff voxels.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a general diagram of temporal and unified mapping, in accordance with an embodiment.

FIG. 2 is a detailed diagram of a mapping framework, in accordance with an embodiment.

FIG. 3 is a diagram of learning-based data association, in accordance with an embodiment.

### DETAILED DESCRIPTION OF EMBODIMENTS

The present disclosure describes a learning-based data association module to better incorporate and unify tasks in 3D semantic mapping.

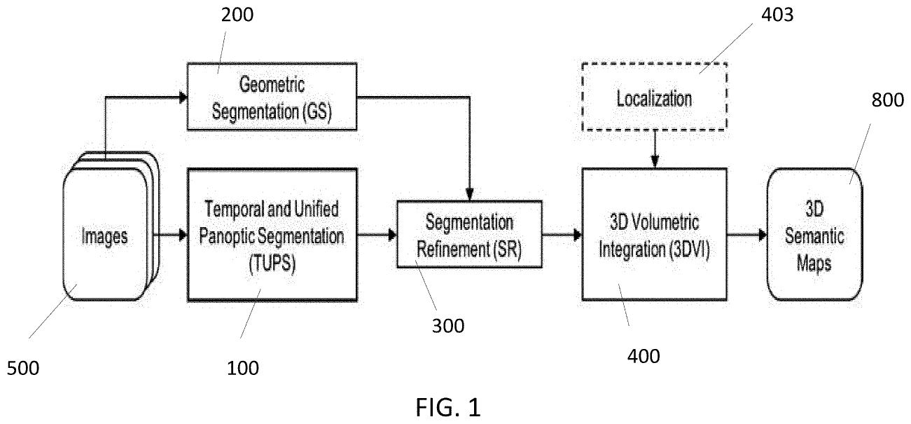

Referring to FIG. 1, in one embodiment, is an overview of this mapping, generally comprising four main modules: Temporal and Unified Panoptic Segmentation (TUPS) 100, Geometric Segmentation (GS) 200, Segmentation Refinement (SR) 300 and 3D Volumetric Integration (3DVI) 400 which ultimately generate 3D semantic maps 800.

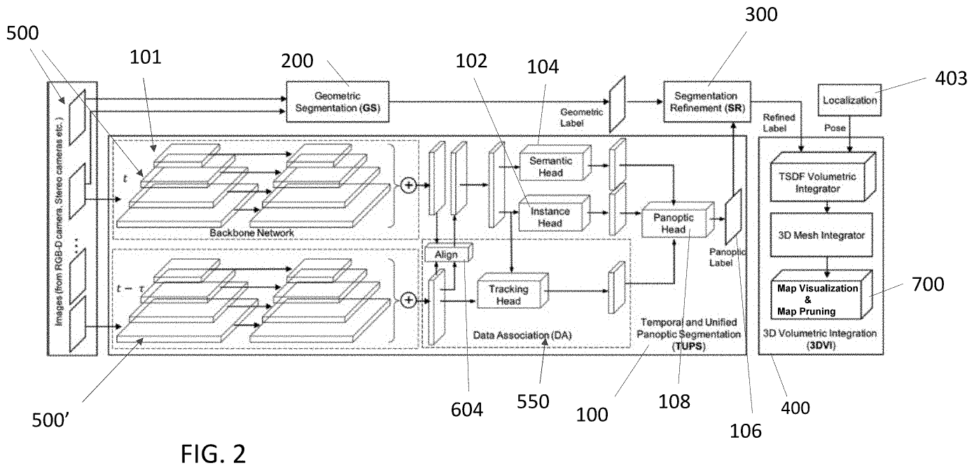

For Temporal and Unified Panoptic Segmentation (TUPS) 100, the unified panoptic segmentation network structure is employed to integrate the heuristic panoptic label fusion module with the loss function of the neural network to realize end-to-end panoptic segmentation. Unified panoptic segmentation is achieved by adopting a shared convolutional feature extraction backbone 101, which exploits ResNet with a FPN, as shown in FIG. 2. The instance head 102 is the same as in the Mask R-CNN. Semantic segmentation head 104 utilizes deformable convolutions. The pixel-wise output 106 of panoptic head 108, which is panoptic label 106 in FIG. 2, is made up by synthesizing different logits of masks, bounding boxes and class labels. Three labels are defined as fetching functions to obtain semantic class label, instance label and panoptic label, respectively. The categories of panoptic can be customized by real-world scenarios, which is to say, the range of semantic class label and instance label can be exchanged accordingly. This serves as the baseline of the panoptic label prediction module, while the semantic branch and instance branch need to be modified correspondingly when processing across different frames. This is discussed in the following part.

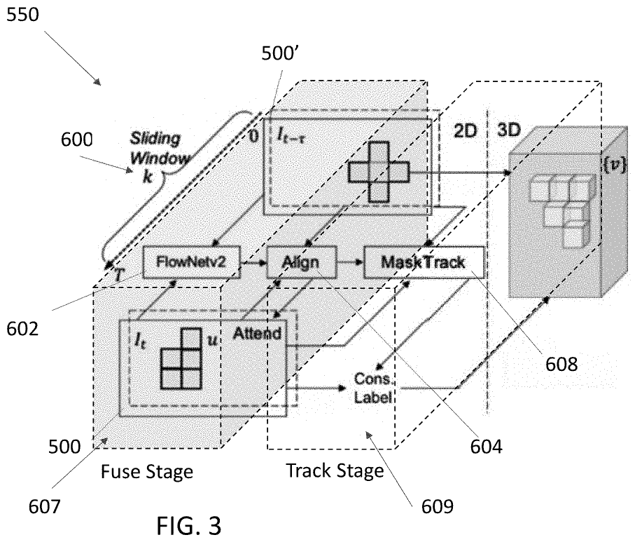

The life cycle of instance identification is only valid within each incoming RGB frame 500 (500′ for frame at time T-tau in FIGS. 2 and 3). Identification inconsistency is introduced when we are processing across different frames. And temporal inconsistency in any of the semantic label and instance label will lead to low map quality. Data association (DA) is normally used to resolve this kind of inter-frame conflict, which is also called label tracking. Here, a new pipeline is introduced to obtain discriminating instance label across different frames as shown in FIG. 3. Motivated by video panoptic segmentation, a learning-based DA module 550 is proposed to be the counterpart of the traditional DA. When it comes to the case consisting of a sequence of multiple frames, a temporal window that spans multiple consecutive frames is considered for map building. Sliding window snippet 600 is a set of input sequences. The target of DA 550 is to predict and track the instance ID for 2D domain frame. The prediction of semantic label is also included because it can provide complementary knowledge to improve instance segmentation. Prediction window slides with a stride through the input image stream.

The diagram of the Learning Based DA 550 is shown in FIG. 3. It is based on video panoptic segmentation net. It is composed of two stages, fuse 607 and track 609, respectively. For fuse stage 607, current frame and reference frame are first fed into a flow net module 602 to estimate an initial optical flow. Then align module 604 utilizes this optical flow to refine aligned features. The attend module 606 is utilized to concatenate all those features and redistribute back to FPN features. Then, all features are fed forward to the following instance and semantic operations.

For track stage 609, due to the semantic label for stuff categories (countable objects such as books, chairs and cars) remain the same through the entire map building process, track stage 609 mainly focuses on associating correct instance label for thing objects (amorphous regions of similar texture or material such as floor, ceiling and sky). Learning based instance tracking receives n region of interest (“RoI”) proposals from current frame and m RoI proposals from reference frame. Then the network tries to learn a feature affinity matrix between two kinds of RoI proposals through feature embedding and cosine similarity measurement. Besides that, attended temporal feature from fuse stage 607 is leveraged to augment the RoI before feeding into the tracking network. In the end, consistent panoptic label s is generated from 2D domain.

For Geometric Segmentation (GS) 200, a geometry-based segmentation module is utilized to be able to discover novel, previously unseen scene elements. At every frame, it generates a set of closed 2D regions and a set of corresponding 3D segments from the depth image. This module is optional, where geometric segmentation can be omitted in the special scenario.

For Segmentation Refinement (SR) 300, for scenarios where both geometry segmentation results from geometric segmentation module 200 and panoptic segmentation results from panoptic label 106 are presented, panoptic labels are utilized to refine geometric labels. Pairwise 2D IoU between geometry segmentations and binary masks are calculated. We extend previous refinement method into panoptic scenario. First, we calculate the IoU of thing objects (such as books, chairs, cars, etc.) to guarantee segments in favor of the thing class. Then, we calculate another IoU for stuff objects (such as floors, walls, sky, etc.) to decide the stuff label for the rest of segments. Lastly, the class label and instance label (only for thing class) of segment are obtained by IoU and corresponding 3D segments are assigned through re-projection. The results are sent to the TSDF volumetric integrator 702

For 3D Volumetric Integration (3DVI) 400, following the processing of Learning Based DA, the pixel of object segments can be directly registered into 3D space without checking the IoU ratio with historical information (inter-frame IoU). The label of corresponding voxel is determined by the intra-frame re-projection model. Camera pose is given by a separate external localization module 403, such as vSLAM, LiDAR SLAM, Odometry, etc. Depth map can be generated from RGB-D camera or estimated from stereo camera. As shown in FIG. 2, we pick voxel hashing TSDF format for presentation of 3D volumetric map, due to the reasons that it can handle large scale map and is beneficial for navigation. Ray casting is adopted to integrate the point cloud, and the TSDF weighting strategy of voxel distance and voxel color remains the same as previous methods. Then the weighting strategy of panoptic label is designed based on its discrete property. Mesh map is also extracted for visualization. The high-resolution mesh can be generated in real-time using marching cubes.

After panoptic label is discriminated for voxels covered in the map, we also add a map pruning module 700 to remove the large chunk of stuff voxels, such as floor, ceiling and wall. This is based on the observation that in certain applications, the information like wall or floor is not needed for robot to navigate and complete the task. As a result, we can reduce the map volume if we can detect those stuff areas then chop or simplify it from the map. For example, large chunk of point cloud can be extracted as 2D boundaries which is more efficient to store. We first build the entire map with all panoptic elements, every stuff regions and thing instances are labeled correspondingly. As described before, Stuff regions only contain category labels, thing objects are made up by category labels and instance labels. For the pruning stage 700, a list of label candidates include category labels and instance labels is collected, then unwanted objects is obtained from the specific robots task. The algorithm will read in the entire map, the map is stored as point cloud form (.PLY format), we leverage the previous voxel hashing TSDF construction procedures, and the redundant TSDF volume will be deleted based on the label of unwanted objects. In the end, pruning module 700 is ending up with extracting finally updated point cloud.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments of the described subject matter can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single device or computer or distributed among multiple devices/computers.

What is claimed is:

1. A system for generating a semantic 3D map, comprising:
a. at least one image capture device capable of capturing and transmitting digital frames of images;
b. a temporal and unified panoptic segmentation module programmed, structed, and/or configured to receive the frames of images from the at least one image capture device and integrate a heuristic panoptic label fusion module with a loss function of a neural network to realize end-to-end panoptic segmentation;
c. a geometric segmentation module programmed, structured and/or configured to receive the frames of images from the at least one image capture device and for discovering previously unseen scene elements, wherein at every frame, it generates a set of closed 2D regions and a set of corresponding 3D segments from a depth image;
d. a segmentation refinement module programmed, structed, and/or configured to refine geometric labels using panoptic labels; and
e. a 3D volumetric integration module programmed, structed, and/or configured to directly register each pixel of object segments into 3D space without checking the IoU ratio with historical information.

2. The system according to claim 1, wherein the temporal and unified panoptic segmentation module includes a convolutional feature extraction backbone, which exploits ResNet with a feature pyramid network (FPN).

3. The system according to claim 1, further comprising a data association module comprising a fuse stage and a track stage.

4. The system according to claim 4, wherein the fuse stage is structured and/or configured to receive current frame and reference frame and feed them into a flow net module to estimate an initial optical flow.

5. The system according to claim 1, wherein the segmentation refinement module is further programmed, structed, and/or configured to calculate intersection over union (“IoU”) of thing objects and for stuff objects, wherein thing objects is data representative of foreground instances and stuff objects is data representative of background regions, all of which can be stored as voxels.

6. The system according to claim 5, further comprising a pruning module programmed, structured, and/or configured to remove at least some of the stuff voxels.
